(19) United States
(12) Patent Application Publication
(10) Pub. No.: US 2021/0283773 A1
(43) Pub. Date: Sep. 16, 2021

(54) ROBOT CLEANER, TERMINAL DEVICE AND CONTROL METHOD THEREFOR

(71) Applicant: Samsung Electronics Co., Ltd., Suwon-se, Gyeonggi-do (KR)

(72) Inventors: Hyun-jin AHN, Yongin-si (KR); Jae-jeong KIM, Seoul (KR); Young-sun SHIN, Seoul (KR); Kyoung-ae LIM, Seongnam-si (KR)

(21) Appl. No.: 16/327,181

(22) PCT Filed: Aug. 18, 2017
(86) PCT No.: PCT/KR2017/009030

§ 371 Date: Feb. 21, 2019

(30) Foreign Application Priority Data
Aug. 30, 2016 (KR) 10-2016-0110734

(51) Int. Cl. B25J 9/16; A47L 9/28; B25J 11/00; B25J 9/00

(52) U.S. Cl. CPC B25J 9/1664; A47L 9/2852; A47L 9/2857; A47L 2201/06; B25J 11/0085; B25J 9/0003; A47L 2201/04; A47L 9/2894

(57) ABSTRACT

Disclosed is a terminal device which can be connected with a robot cleaner. The terminal device includes: a storage for storing spatial information partitioned into a plurality of spaces; a communication interface for receiving, from the robot cleaner, cleaning result information including a cleaning path; a display unit for displaying the cleaning result information; and a processor for controlling the display unit such that a cleaning area of the robot cleaner for each of the plurality of spaces is displayed on the basis of the received cleaning result information and the stored spatial information.

### CROSS-REFERENCE TO RELATED APPLICATION(S)

This application is based on and claims priority under 35 U.S.C. § 119(a) of a Korean patent application number 10-2016-0110734, filed on Aug. 30, 2016, in the Korean Intellectual Property Office, the disclosure of which is incorporated by reference herein in its entirety.

### BACKGROUND

### 1. Field

The disclosure relates to a robot cleaner, a terminal device, and a control method therefor and, more particularly, to a robot cleaner which is capable of partitioning a cleaning result of a robot cleaner into a space unit and providing the result to a user, a terminal device and a control method therefor.

### 2. Description of Related Art

In general, robots have been developed for industry use and are widely used in various industrial fields. Recently, a field using a robot is further enlarged to a medical field, a space aviation field, and a general household.

A representative of a robot used in a household is a robot cleaner. The robot cleaner performs a function to clean by sucking a foreign substance such as dust while driving on an indoor space in a house.

However, a user is not highly satisfied with a related-art robot cleaner, since the robot cleaner does not accurately provide information about how cleaning is performed for a user.

Accordingly, a recent robot cleaner has a function of providing a movement path during a cleaning process to a user terminal device.

However, the related art merely provides a user with only an entire movement trajectory during a cleaning process, and it is difficult for a user to check a cleaning area of a robot cleaner.

For example, in order to check how cleaning of an actual space (e.g., a main room) is performed, a user has to directly infer which area in the entire movement trajectory corresponds to the main room. Furthermore, the entire movement path is displayed at a time and it is difficult to grasp cleaning states of each space (for example, a main room, a kitchen, or the like).

### SUMMARY

The disclosure is to address at least the above-mentioned problems and/or disadvantages and to provide at least the advantages described below. Therefore, the disclosure is to provide a robot cleaner which may partition cleaning result by the robot cleaner into spaces and provide a user with the same, a terminal device, and a control method thereof

According to the disclosure, a terminal device connectable to a robot cleaner includes a storage configured to store spatial information partitioned(or divided) into a plurality of spaces; a communication interface configured to receive, from the robot cleaner, cleaning result information including a cleaning path; a display configured to display the cleaning result information; and a processor configured to control the display such that a cleaning area of the robot cleaner for each of the plurality of spaces is displayed on a basis of the received cleaning result information and the stored spatial information.

The processor may control the display to display a cleaning area of the robot cleaner with respect to a space in which cleaning is performed, from among the plurality of spaces.

The processor may control the display to display a map of a space in which cleaning is performed along with a cleaning area on the map.

The processor may control the display to display a cleaning area in which cleaning is performed along with a movement path of the robot cleaner on the cleaning area.

The processor may partition a cleaning path included in the cleaning result information into a plurality of spaces based on the spatial information, and generate a cleaning area image of the robot cleaner by a plurality of spaces based on the partitioned cleaning path.

The cleaning result information may include a plurality of cleaning paths which are partitioned by a plurality of spaces, and the processor may generate a cleaning area image of the robot cleaner by a plurality of spaces based on the plurality of cleaning paths.

The communication interface may receive, from the robot cleaner, map information generated from the robot cleaner, and the processor may generate spatial information partitioned into a plurality of spaces based on the received map information and store the same in the storage.

The processor may, based on at least one space among the plurality of spaces being selected by a user, control the communication interface so that a cleaning command with respect to the selected space is transmitted to the robot cleaner.

The processor may, based on to any one cleaning area being selected from among the displayed cleaning areas by spaces, control the display to enlarge and display the selected cleaning area.

A robot cleaner according to an embodiment of the disclosure includes a driver configured to move the robot cleaner; a suction portion configured to suck dust on a bottom of the robot cleaner; a communication interface configured to receive spatial information partitioned into a plurality of spaces from a terminal device; and a processor configured to move the robot cleaner to perform cleaning and control the communication interface to transmit cleaning result information including a cleaning path of the robot cleaner by a plurality of spaces based on the received spatial information to the terminal device.

The processor may control the communication interface to transmit, to the terminal device, cleaning result information that includes only cleaning paths of each of a space in which cleaning is performed from among the plurality of spaces.

The processor may, based on a cleaning command for a specific space, from among the plurality of spaces, being received from the terminal device, control the robot cleaner by moving the robot cleaner to the specific space to perform cleaning on a basis of the received spatial information.

The processor may control the communication interface to generate map information according to movement of the robot cleaner and transmit the map information to the terminal device, and the spatial information, based on the generated map information being partitioned into a plurality of spaces, may be location information of each of the plurality of partitioned spaces.

The communication interface may receive cleaning schedule information from the terminal device, and the processor may perform cleaning according to the received cleaning schedule information.

According to an embodiment of the disclosure, a control method of a terminal device connectable to a robot cleaner includes prestoring spatial information partitioned into a plurality of spaces; receiving, from the robot cleaner, cleaning result information including a cleaning path; and displaying a cleaning area of the robot cleaner by the plurality of spaces based on the received cleaning result information and the stored spatial information.

In this case, the displaying may include displaying a cleaning area of the robot cleaner with respect to a space where cleaning is performed from among the plurality of spaces.

The displaying may include displaying a map of the space where the cleaning is performed and the cleaning area on the map.

The displaying may include displaying a cleaning area of the space where cleaning is performed and the movement path of the robot cleaner on the cleaning area.

The control method may further include the step of partitioning the cleaning path included in the cleaning result information into a plurality of spaces based on the spatial information, generating a cleaning area image of the robot cleaner by the plurality of spaces based on the partitioned cleaning path and displaying the generated image of the cleaning area.

Meanwhile, the cleaning result information may include a plurality of cleaning paths separated by a plurality of spaces, and the displaying step may include generating a cleaning area image of the robot cleaner for each of a plurality of spaces based on the plurality of cleaning paths and displaying the generated cleaning area image.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating a configuration of cleaning system according to an embodiment of the disclosure,

FIG. 2 is a block diagram illustrating a configuration of the robot cleaner of FIG. 1,

FIG. 3 is a block diagram illustrating a configuration of the terminal device of FIG. 1,

FIG. 4 is a view illustrating various examples of the user interface window that can be displayed on the display of FIG. 3,

FIG. 5 is a view illustrating various examples of the user interface window that can be displayed on the display of FIG. 3,

FIG. 6 is a view illustrating various examples of the user interface window that can be displayed on the display of FIG. 3,

FIG. 7 is a view illustrating various examples of the user interface window that can be displayed on the display of FIG. 3,

FIG. 8 is a view illustrating various examples of the user interface window that can be displayed on the display of FIG. 3,

FIG. 9 is a view illustrating various examples of the user interface window that can be displayed on the display of FIG. 3,

FIG. 10 is a view illustrating various examples of the user interface window that can be displayed on the display of FIG. 3,

FIG. 11 is a flowchart to describe a control method of the robot cleaner according to an embodiment of the disclosure, and

FIG. 12 is a flowchart to describe a control method of a terminal device according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

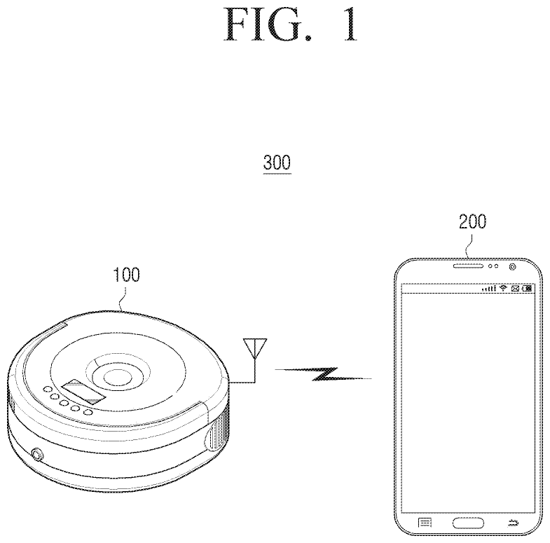

FIG. 1 is a block diagram illustrating a configuration of cleaning system according to an embodiment of the disclosure.

Referring to FIG. 1, a cleaning system 300 includes a robot cleaner 100 and a terminal device 200.

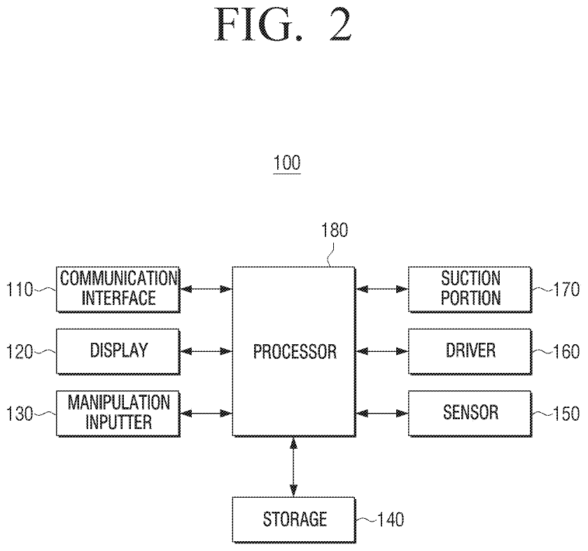

The robot cleaner 100 is drivable and sucks foreign substances such as dust on a floor surface. The robot cleaner 100 performs cleaning according to a cleaning command or a cleaning schedule transmitted from the terminal device 200. In the cleaning process, the robot cleaner 100 stores a movement path (or a cleaning path), generates cleaning result information including the stored movement path, and transmits the cleaning result information to the terminal device 200. The specific configuration of the robot cleaner 100 will be described later with reference to FIG. 2.

The terminal device 200 can generate a cleaning schedule and provide the generated cleaning schedule to the robot cleaner 100. The terminal device 200 may receive a cleaning command from the user and provide the cleaning command to the robot cleaner 100. The user can input a cleaning command for a specific space (for example, a living room, a main room, etc.) as well as a cleaning command for the entire space.

The terminal device 200 may receive the cleaning result information received from the robot cleaner 100 and display a cleaning schedule of the robot cleaner and the cleaning result information to a user.

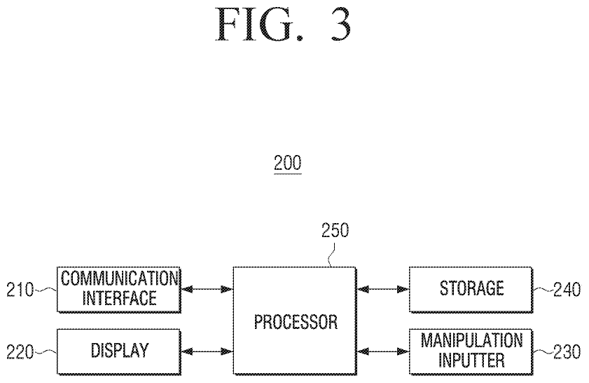

When displaying the cleaning result information, the terminal device 200 may display the cleaning area of the robot cleaner in an image form by partitioning the cleaning area into a plurality of spaces. Accordingly, the user can easily check the cleaning state of the robot cleaner by spaces. The specific configuration and operation of the terminal device 200 will be described later with reference to FIG. 3.

As described above, the cleaning system 300 according to the embodiment provides the cleaning result of the robot cleaner as a plurality of cleaning areas for each space, so that the user can easily check the cleaning result for each space. In addition, since the cleaning system 300 provides a cleaning function for each space, and the user can provide a cleaning service for a space that requires cleaning without complicated operations.

In describing FIG. 1, the robot cleaner 100 is directly connected to the terminal device 200, but in implementation, the robot cleaner 100 may be connected to the terminal device 200 through a relay device such as an access point (AP), a router, or the like, and may be connected through a separate server such as a home server or the like.

In FIG. 1, it is described that one robot cleaner and one terminal device are connected in the cleaning system 300, but in the cleaning system 300, there may be a plurality of robot cleaners which simultaneously operate and each robot cleaner can be connected to a plurality of terminal devices. In addition, one terminal device may be connected to a plurality of robot cleaners.

Further, in FIG. 1, it is described that a cleaning command for a robot cleaner is input through the terminal device 200, but it is also possible to receive a cleaning command directly from the robot cleaner. In addition, it has been described that the cleaning area for each space is displayed on the terminal device 200, but if there is a display function in the robot cleaner, a cleaning area for each space can be displayed on a robot cleaner.

FIG. 2 is a block diagram illustrating a configuration of the robot cleaner of FIG. 1.

Referring to FIG. 2, the robot cleaner 100 according to an embodiment may include a communication interface 110, a display 120, a manipulation inputter 130, a storage 140, a sensor 150, a driver 160, a suction portion 170, and a processor 180.

The communication interface 110 is formed to connect the robot cleaner 100 to an external device (specifically, a terminal device or a home server), and can be accessed not only by a short-range wireless communication (for example, Bluetooth, Wi-Fi, WiFi Direct), but also a remote wireless communication (e.g., wireless communication such as global system for mobile communications (GSM), universal mobile telecommunications system (UMTS), long-term evolution (LTE), and wireless broadband (WiBRO)).

The communication interface 110 receives the cleaning schedule information from the terminal device 200. The cleaning schedule information includes time information (e.g., a cleaning start time or a cleaning completion time), and spatial information (e.g., whole space or a partial space). Here, the space may be a space partitioned by a user or a structure among the whole spaces where the robot cleaner is able to move (for example, a living room, a kitchen, a main room, and the like). Therefore, spatial information is information regarding a plurality of partitioned spaces and may be referred to as partition information.

The communication interface 110 receives a cleaning command The cleaning command may be a cleaning command for the entire space, or a cleaning command for a specific space or a specific location. Here, the position means a specific point within a specific space.

The communication interface 110 receives spatial information. Specifically, the communication interface 110 may receive, from the terminal device 200, spatial information partitioned into a plurality of spaces. The spatial information may be an image file such as a map (specifically, a floor plan) of information on a plurality of spaces of a home (or a company) where the robot cleaner is located, and a data file including a plurality of coordinates with respect to a specific location. The spatial information may be generated based on map information generated by the robot cleaner.

The communication interface 110 transmits the cleaning result information. Specifically, at a time when the cleaning is completed or when a request for providing information is received from the terminal device 200, the communication interface 110 may transmit the cleaning result information to the terminal device 200. The cleaning result information includes a cleaning path of the robot cleaner and may further include map information, error information, non-cleaned area information that are generated in the robot cleaner.

The display 120 may display various information of the robot cleaner 100. The display 120 may be a monitor in a small size such as an LCD and can be implemented as a touch screen capable of simultaneously performing functions of the manipulation inputter 130 to be described later.

The display 120 may display information on an operation state of the robot cleaner 100 (whether the mode is a cleaning mode or an idle mode), information on progress of cleaning (for example, cleaning progress time, current cleaning mode (for example, suction intensity), battery information, whether the battery is charged, whether the dust container is full of dust, and an error state (liquid contact state) and the like. If an error is detected, the display 120 may display the detected error.

The display 120 may display a cleaning area for each space. Specifically, the display 120 may display the cleaning area in response to the history display command of the user. At this time, the display unit 120 may display the cleaning area by partitioning the area into a plurality of spaces. In addition, when only a part of the plurality of spaces is cleaned, the display 120 may display only the cleaning area for the cleaned space.

The manipulation inputter 130 includes a plurality of function keys for enabling a user to set or select various functions supported by the terminal device 200. The manipulation inputter 130 may be implemented as a device such as a plurality of buttons, and may be implemented as a touch screen capable of simultaneously performing functions of the display 120.

The manipulation inputter 130 may receive an on/off command of a cleaning function, a command to select a cleaning mode, a command to re-clean a non-cleaned area, and a command to clean a specific space, or the like.

The storage 140 may store various programs and data for operating the robot cleaner 100. The storage 140 may be implemented with a non-volatile memory, volatile memory, flash memory, hard disk drive (HDD), solid state drive (SSD), or the like.

The storage 140 may store the cleaning schedule information received through the communication interface 110. At this time, the storage 140 may store a plurality of cleaning schedule information in different cleaning time zones. For example, the storage 140 may store the first schedule information for performing the cleaning for the entire space at 12 o'clock on weekdays, the second schedule information for performing the cleaning for a specific space (for example, living room) at two o'clock on Saturday and Sunday, and the like. In the above description, it is assumed that all of the plurality of schedule information is a periodic schedule, but one cleaning schedule may be a one-time schedule that is not periodic.

The storage 140 may store the generated map information according to the driving of the driver 160. Here, the map information is information indicating a movement path of the robot cleaner during the cleaning process, and may be an image form or a trajectory data in a coordinate form. The movement path is the entire path of the robot cleaner during cleaning process, and the cleaning path means a path in which the dust suction operation is performed in the suction portion of the entire path. Therefore, the movement path is used when the map information is generated, but a cleaning path can be used when the cleaning result information to be described later is generated. However, the disclosure can be implemented such that the suction operation is performed in the movement process at the time of implementation, and the cleaning result information can be generated by using the movement path. It is also possible to interpret the movement path to be described later as a cleaning path, and conversely, it can be interpreted as a movement path.

The storage 140 may store the spatial information provided by the terminal device 200. Here, the spatial information is position information on the map information of each space when the map information is partitioned into a plurality of spaces. Thus, if the map information is in the form of an image, the spatial information may also be in the form of a map.

The storage 140 may store the history and the like generated during the cleaning process as history information. Here, the history information may include cleaning time, information on the number of times of charging, information on the number of times of occurrence of errors, information on each error, information on a non-cleaned area, or the like.

The sensor 150 detects an obstacle around the robot cleaner 100. Specifically, the sensor 150 can sense the position of the obstacle around the robot cleaner 100 and the distance to the obstacle by using a supersonic sensor, an infrared sensor, a radio frequency (RF) sensor, or the like. The sensor 150 may further include a collision sensor for detecting an obstacle through collision with the obstacle.

The sensor 150 detects an object located on the front surface of the robot cleaner. Specifically, the sensor 150 includes a capturing portion which is capable of capturing a front surface of the robot cleaner 100, and can detect an object through image processing in an image captured by the capturing portion. An image which captures an object that requires suction or detour can be stored in the storage 140.

The sensor 150 may detect the degree of dust on the bottom. Specifically, the sensor 150 may include a dust sensor that detects the degree of dust in the air entering the suction portion. Accordingly, if the amount of dust detected in real time is reduced to a predetermined amount, the sensor 150 can determine that the cleaning has been performed well.

The sensor 150 detects whether the robot cleaner 100 is in contact with liquid. More specifically, the sensor 150 may detect whether the liquid is in contact with wheels which constitute the driver 160 of the robot cleaner 100.

The driver 160 moves the robot cleaner. The driver 160 is connected to one or more wheels and includes a driving unit such as a motor. The driver 160 performs a traveling operation such as a movement, a stop, and a direction change according to a control signal of the processor 180.

The suction portion 170 sucks dust on the bottom surface of the robot cleaner 100. Specifically, the suction portion 170 can suck foreign substances in the lower part during the movement or stop, thereby performing the cleaning operation. The suction portion 170 may further include an air purification unit for purifying contaminants in the air.

The suction portion 170 has a plurality of operation modes. Here, the operation mode can be classified according to the suction intensity. Such an operation mode may be set by a user in advance, and may vary depending on the weather. For example, if the operation mode is divided into 1 to 5 according to the suction intensity, and the user sets the default value to 3, if there is a yellow dust or fine dust warning, the suction portion 170 may be operating with an operation mode which a default value of the suction intensity is increased (for example the default value can be 4 or 5).

The processor 180 performs control for each configuration in the robot cleaner 100. Specifically, the processor 180 may initiate a cleaning operation according to a cleaning schedule. At this time, the processor 180 may control the suction portion 170 to operate in an operation mode corresponding to weather information based on the weather information received from the server or the terminal device. For example, in the event that the weather information includes yellow dust or fine dust warnings, the processor 180 may control the suction section 170 to operate at a higher suction intensity than the default suction intensity. Conversely, in the summer with little dust, the processor 180 can control the suction portion 170 to operate with a suction intensity lower than the default suction intensity.

The processor 180 may control the driver 160 to move the robot cleaner 100 according to the stored map information and control the suction portion 170 to perform cleaning at the time of moving or stopping the robot cleaner 100. Specifically, when a cleaning command for a specific space is received from the terminal device 200, the processor 190 may control the driver 160 to move the robot cleaner to the corresponding space based on the stored map information, and if the movement to the corresponding space is confirmed, the cleaning operation can be performed.

If there is no pre-stored map information, the processor 180 may control the driver 160 to move the robot cleaner 100 according to a predetermined algorithm, and generate the map information according to the movement trajectory of the robot cleaner 100. When the map information is generated, the processor 180 can control the communication interface 110 to transmit the generated map information to the terminal device 200.

When the robot cleaner 100 requires charging according to a power state in the robot cleaner 100, the processor 180 may control the driver 160 to move the robot cleaner 100 to a charging station for charging.

The processor 180 may control the driver 160 and the suction portion 170 according to the degree of dust detected by the sensor 150. For example, in an area where dust is infused in a large amount, the cleaning efficiency can be improved by slowing the repetitive driving and running speed or by increasing the suction force of the suction portion 170. Conversely, the processor may control the driver 160 to increase the traveling speed in an area where no dust is introduced.

When the cleaning is completed, the processor 180 may control the communication interface 110 such that cleaning result information including a cleaning path of the robot cleaner is provided to the terminal device 200. At this time, the processor 180 may generate cleaning result information including a cleaning path of the robot cleaner by a plurality of spaces based on the spatial information, and may control the communication interface 110 to transmit the generated cleaning result information.

In the implementation, cleaning result information including only one cleaning path may be generated and provided by the terminal device 100, and the cleaning path received from the terminal device 100 may be partitioned into a plurality of spaces. At the time of implementation, the processor 180 may not provide a cleaning path for each space, but generate an image of a cleaning area for each space, and provide the cleaning area image for each space to the terminal device 200 as cleaning result information.

The processor 180 may control the communication interface 110 so that the initial map information is provided to the terminal device 200. To be specific, when the robot cleaner 100 performs an initial cleaning operation, map information on a space where the robot cleaner can move is generated.

The processor 180 may provide the generated map information to the terminal device 200 and perform the cleaning operation using the map information generated in the subsequent cleaning process. When the robot cleaner is moved to another environment and recognizes that the map information is different from previously stored map information, the processor 180 may update the existing map information and control the communication interface 110 to provide the updated map information to the terminal device 200. At the time of implementation, the map information can be updated not only when moving to another environment but also when the furniture arrangement is changed or a new furniture is arranged and the cleanable area is changed.

As described above, since the robot cleaner 100 according to the embodiment can perform cleaning using the spatial information partitioned into a plurality of spaces, the robot cleaner 100 can perform a cleaning operation for only a specific space. Also, since the robot cleaner 100 according to the embodiment provides the cleaning path for each space to the terminal device 200 as the cleaning result information, the user can easily check the cleaning state for each space.

FIG. 3 is a block diagram illustrating a configuration of the terminal device of FIG. 1.

Referring to FIG. 3, the terminal device 200 according to the embodiment includes a communication interface 210, a display 220, a manipulation inputter 230, a storage 240, and a processor 250. The terminal device 200 may be a smartphone, a notebook, a PMP, an MP3 player, a smart TV, and a wearable device (for example, a smart watch), or the like.

The communication interface 210 is formed for connecting the terminal device 200 to an external device (specifically, a robot cleaner and an Internet network), and can be accessed not only by a short-range wireless communication (local area network (LAN)) and Internet network but also a wireless communication (e.g., Z-wave, 4LoWPAN, radio frequency identification (RFID), long-term evolution device-to-device (LTE D2D), Bluetooth low energy (BLE), general packet radio system (GPRS), Weightless, Edge Zigbee, ANT+, near field communication (NFC), infrared data association (IrDA), digital enhanced cordless telecommunications (DECT), wireless local area network (WLAN), Bluetooth, Wi-FI, Wi-Fi Direct, global system for mobile communications (GSM), universal mobile telecommunications system (UMTS), long-term evolution (LTE), and wireless broadband (WiBRO)).

The communication interface 210 transmits the cleaning schedule information. Specifically, the communication interface 210 can transmit the cleaning schedule information set by the user to the robot cleaner 100. In addition, the communication interface 210 can transmit a cleaning command to the robot cleaner 100. Here, the cleaning command may be a cleaning command for the entire space, and may be a cleaning command for a specific space (for example, a living room).

The communication interface 210 receives cleaning result information. Specifically, the communication interface 210 may receive cleaning result information which includes a cleaning path of the robot cleaner. Here, the cleaning path may be all paths through which the robot cleaner moves during one cleaning process or paths which are partitioned by spaces. In implementation, a cleaning area image by spaces according to cleaning paths can be received as cleaning result information, instead of a cleaning path.

The display 220 may display various types of information to the terminal device 200. The display 220 may be a monitor such as a liquid crystal display (LCD), a cathode ray tube (CRT), or the like, and may be implemented as a touch screen capable of simultaneously performing a function of a manipulation inputter 230 to be described later.

The display 220 displays the received cleaning schedule information and cleaning result information. Specifically, the display 220 may display the cleaning schedule information of the robot cleaner according to the user's selection. At this time, the display 220 can display the map information generated by the robot cleaner 100 and information on the scheduled movement path of the robot cleaner. Also, the display 220 can display information such as a cleaning start time and a cleaning time.

The display 220 can display the cleaning result information. Specifically, the display 220 may display an image corresponding to a cleaning area of the robot cleaner by a plurality of spaces. Specifically, the display 220 may generate a cleaning area image for each of the plurality of space cleaning paths by reflecting the cleaning width of the robot cleaner, and may display the generated cleaning area image for each space. At this time, the generated cleaning area image may or may not include a cleaning path. In addition, the cleaning area image may be a composite form with previously generated map information, or a non-composite room.

When one of the displayed images is selected, the display 220 may enlarge an image regarding a cleaning area corresponding to the selected area and display the image.

Also, the display 220 can display the time required for cleaning and whether an error has occurred when the cleaning result information is displayed. If there is a history of sucking an object or there is a non-cleaned area, this information can be displayed together. Accordingly, the user can easily confirm the cleaning operation of the robot cleaner 100, confirm the object sucked by the robot cleaner 100, and easily confirm the area in which the cleaning is not performed.

The manipulation inputter 230 includes a plurality of function keys through which the user can set or select various functions supported by the terminal device 200. The manipulation inputter 230 may be implemented as a device such as a mouse or a keyboard, or may be implemented as a touch screen capable of simultaneously performing the functions of the display 220.

The manipulation inputter 230 can receive the cleaning schedule of the robot cleaner from the user. The manipulation inputter 230 may receive a control command for the driving state of the robot cleaner 100. For example, the robot cleaner 100 may receive a command to clean the robot cleaner 100 when the robot cleaner 100 is not in the predetermined cleaning schedule. The manipulation inputter 230 may receive a cleaning command for the entire area on the cleaning map, or may receive a cleaning command for the specific area.

The manipulation inputter 230 can receive a display command of the cleaning history of the robot cleaner. The manipulation inputter 230 may receive a selection command for selecting any of the displayed cleaning histories. In addition, the manipulation inputter 230 may receive a command for selecting any of the displayed cleaning areas by spaces.

The storage 240 may store various programs and data necessary for the operation of the terminal device 200. The storage 150 may be implemented as a non-volatile memory, a volatile memory, a flash memory, a hard disk drive (HDD), or a solid state drive (SSD). The storage 240 is accessed by the processor 250, and data read/write/modify/delete/update by the processor 140 can be performed. The term storage in this disclosure includes a storage 240, a read-only memory (ROM) (not shown), a random-access memory (RAM) (not shown) in the processor 250, or a memory card (not shown) (for example, micro secure digital (SD) card and memory stick) mounted to the terminal device 200.

Specifically, the storage 240 may store programs and data for configuring various screens to be displayed on the user interface window. The storage 240 may store a program, which is a set of various commands necessary for driving the terminal device 200. Here, the program includes an application (or an application program) for providing a specific service as well as an operating program for operating an application.

The storage 240 may store cleaning schedule generated in the processor 250 and store cleaning result information received through the communication interface 210.

The storage 240 may store map information received through the communication interface 210 and store spatial information generated according to the map information.

The processor 250 controls each configuration in the terminal device 200. Specifically, the processor 250 controls the overall operation of the terminal device 200 using various programs stored in the storage 240. For example, the processor 250 may include a central processing unit (CPU), RAM, ROM, and a system bus. Here, the ROM is a configuration in which a command set for booting the system is stored. The CPU copies the operating system stored in the storage 240 to the RAM according to the command stored in the ROM, and executes the O/S to boot the system. When the booting is completed, the CPU can copy various applications stored in the storage 240 to the RAM, execute the application, and perform various operations. Although the processor 250 has been described as including only one CPU in the above description, the processor 250 may be implemented by a plurality of CPUs (or digital signal processors (DSP), systems-on-chips (SoCs), etc.)

When the terminal device 200 is booted, the processor 250 causes the application for the control of the robot cleaner or the creation of the cleaning schedule to be activated and controls the display 220 to display the user interface window corresponding to the application.

The processor 250 may control the communication interface 210 to generate a cleaning schedule of the robot cleaner according to the control command received from the user, and transmit the generated cleaning schedule to the robot cleaner 100 so that an operation according to the generated cleaning schedule is performed.

When the processor 250 receives a cleaning command from the user, the processor 250 may control the communication interface 210 to transmit a cleaning command Specifically, when a cleaning command is inputted from the user, the processor 250 may control the display 220 to display the spatial information for selecting a space to be cleaned, and when the specific space is selected from the displayed space, the processor may generate a cleaning command for the selected specific space and transmit the cleaning command to the robot cleaner 100.

When the processor 250 receives the map information from the robot cleaner 100, the processor 250 generates the spatial information based on the received map information. Specifically, the processor 250 sets the entire area (i.e., the size of the house) that the robot cleaner can move based on the received map information, and partitions the entire area into a plurality of spaces based on the movement path. Such an operation may be automatically partitioned through a predetermined algorithm, and may be partitioned through a user's manipulation.

When a plurality of spaces are partitioned, the processor 250 may set names of each area or receive names of a plurality of areas.

The processor 250 may control the display 220 to display the cleaning result of the robot cleaner. Specifically, the processor 250 may control the display 220 to generate an image corresponding to the cleaning area of the plurality of space-based robot cleaner based on the path information and the spatial information in the received cleaning result information, and display the generated cleaning area image.

When one of the displayed cleaning area image (or space) is selected, the processor 250 may control the display 220 to display an enlarged image of the selected cleaning area image.

As described above, the terminal device 200 according to the embodiment can input a cleaning command for each space by using the spatial information partitioned into a plurality of spaces, thereby improving user convenience. In addition, the terminal device 200 according to the embodiment provides the user with a cleaning area for each space, so that the user can easily check the cleaning state for each space.

In the above description, the terminal device 200 has been described as generating spatial information and provide the generated spatial information to the robot cleaner. However, in the implementation, the robot cleaner can generate spatial information by itself Alternatively, a separate server (not shown) instead of the terminal device 200 and the robot cleaner 100 may generate spatial information using the map information and provide the generated spatial information to the terminal device 200 or the robot cleaner 100.

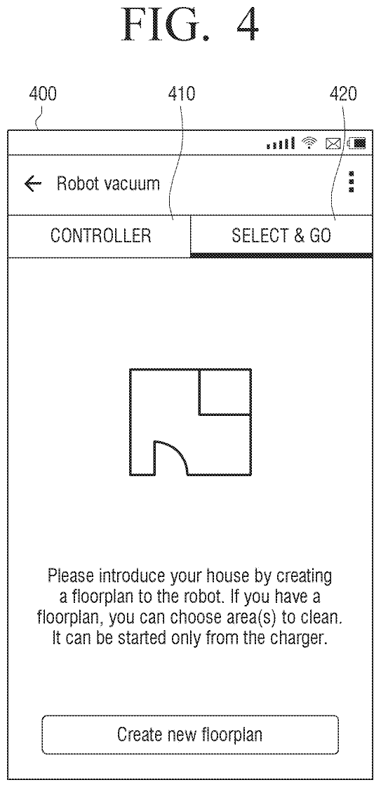

FIGS. 4 to 10 are views illustrating various examples of the user interface window that can be displayed on the display of FIG. 3.

Specifically, FIG. 4 is a view to illustrate an example of the user interface window which is displayed when the cleaning application is initially driven.

Referring to FIG. 4, the user interface window 400 includes a control area 410 and a space selection area 420.

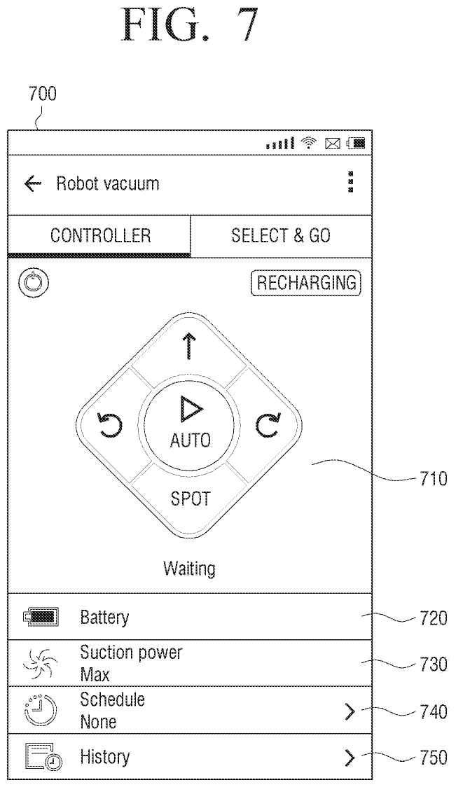

The control area 410 is an area to display a menu for receiving various user control commands to control an operation of the robot cleaner. When the control area 410 is selected, a user interface window as illustrated in FIG. 7 can be displayed.

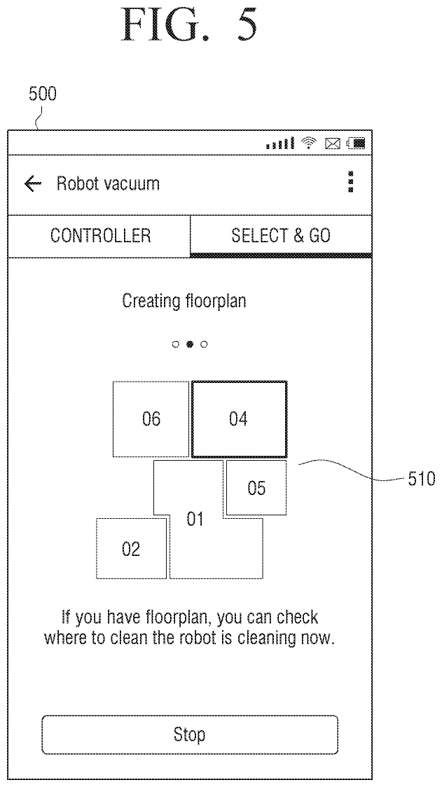

The space selection area 420 is an area for displaying a menu for receiving a cleaning command by spaces. In FIG. 4, the spatial selection area 420 is selected. Since the spatial information is not yet generated, a message indicating that generation of the spatial information is required is displayed at the bottom of the spatial selection area 420. If the spatial information is pre-generated, and if the spatial selection area 420 is selected, a user interface window as shown in FIG. 5 may be displayed.

As illustrated in FIG. 4, when a user requests generation of the spatial information in a message window, the terminal device 200 may generate spatial information by partitioning the area in the map information received from the robot cleaner 100 into a plurality of spaces. In the meantime, generating spatial information using map information generated by the robot cleaner is a well-known art and thus will not be further described in the disclosure.

FIG. 5 is an example of the user interface window that is displayed when the spatial information is pre-generated.

Referring to FIG. 5, the user interface window 500 displays spatial information 510 partitioned into a plurality of spaces. In the illustrated example, the spatial information divided into five spaces is illustrated. However, there may be only one space depending on the environment in which the robot cleaner is present at the time of implementation, and a space divided into two to four or six or more spaces can be present.

In the illustrated example, each space is marked with the number, but a user may set desired names (for example, a living room, a main room, kitchen, etc.) for each space through setting.

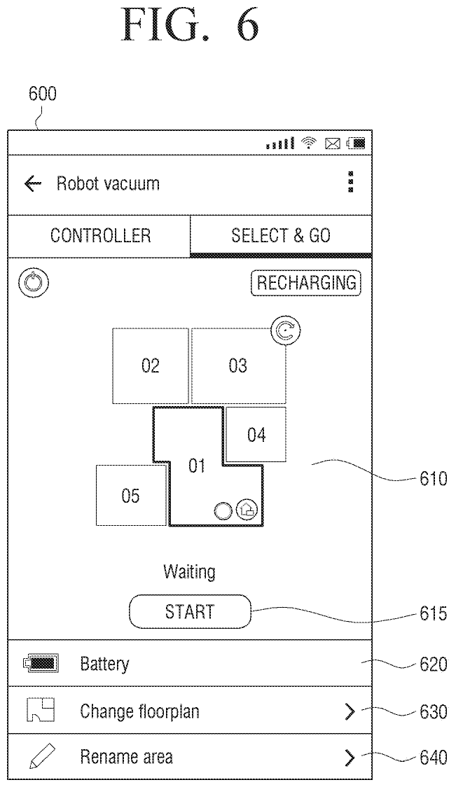

The user can select a space for performing cleaning on the displayed spatial information. For example, if a space 01 is selected from the space shown in FIG. 6, a user interface window as shown in FIG. 6 may be displayed.

FIG. 6 is an example of the user interface window that can be displayed when a specific space to be cleaned is selected.

Referring to FIG. 6, the user interface window 600 includes a spatial information display area 610, a cleaning start command area 615, a battery information display area 620, a change floor plan area 630, and a rename area 640.

The spatial information display area 610 displays information on an area which is partitioned into a plurality of spaces and displays an area selected by the user in the preceding process as well.

The cleaning start command area 615 is an area for receiving a cleaning start command for the spatial information display area 610. When the user selects the cleaning start command area 615, the terminal device 200 can transmit a cleaning start command for the “01” space to the robot cleaner 100.

The battery information display area 620 is an area for displaying the battery status of the robot cleaner. Although only the battery status is shown in the illustrated example, other statuses of the robot cleaner as well as the battery status may be displayed at the time of implementation. For example, dust amount information in a dust container, error information or the like may be displayed.

The change floor plan area 630 is an area to receive a user command to change partitioning of the space. When the change floor plan area 630 is selected, spatial information can be regenerated by returning to the process of FIG. 4.

The rename area 640 is an area to correct names of each space. When the rename area 640 is selected, a user interface window to select names of the partitioned spaces can be displayed.

FIG. 7 is an example of the user interface window displayed when the control area 410 of FIG. 4 is selected.

Referring to FIG. 7, a user interface window 700 includes a control UI display area 710, a battery status display area 720, a suction power display area 730, a schedule display area 740, and a cleaning history display area 750.

The control UI display area 710 is a UI display area for receiving a plurality of control commands for the robot cleaner and includes commands such as a cleaning pause, a forwarding command, a left rotation command, a right rotation command, repetitive cleaning of a specific area and so on.

The battery status display area 720 is an area for displaying the battery status of the current robot cleaner. At the time of implementation, not only the battery status but also various states of the robot cleaner (for example, presence of errors and dust amount in the dust bin) can be displayed.

The suction power display area 730 is an area to display suction intensity of the robot cleaner.

The schedule display area 730 is an area for receiving a command for displaying a cleaning schedule set in the current robot cleaner. The user can select the corresponding area to check the cleaning schedule set in the robot cleaner, or add or change a new cleaning schedule.

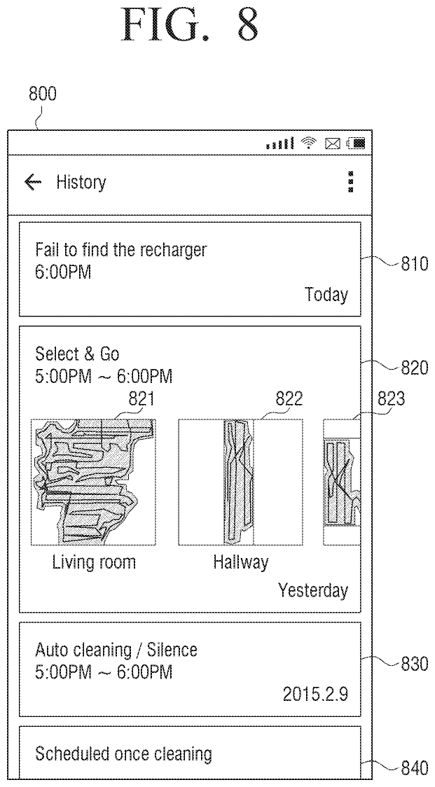

The cleaning history display area 740 is an area to display a pre-performed cleaning history. When the corresponding area is selected, the user interface window such as FIG. 8 can be displayed.

FIG. 8 is an example of the user interface window displaying cleaning history.

Referring to FIG. 8, the user interface window 800 displays a plurality of cleaning histories 810, 820, 830, and 840. One of a plurality of cleaning histories displays cleaning areas by spaces as images 821, 822, and 823. The user can move the cleaning history 820 to the left and right to confirm the cleaning area for each space. Meanwhile, although the cleaning area is displayed for only one history in the illustrated example, the cleaning history image for each space may be displayed for every history at the time of implementation. However, in the case of displaying the cleaning area image for all the cleaning history, the number of cleaning history displayed on the screen is reduced. In the case of implementation, the cleaning history image is displayed only for the recent history, and for other histories, only a cleaning history image can be displayed for recent history only. If the user selects the history even in such a case, the cleaning area image for each areas can be displayed for the corresponding cleaning history.

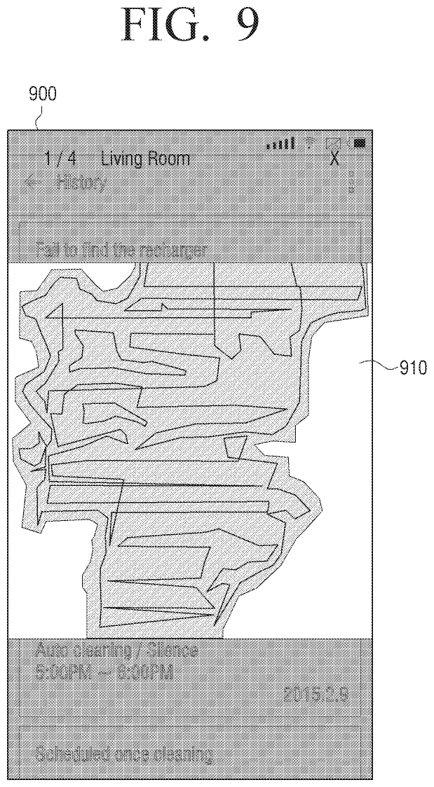

The user may select one of the displayed cleaning areas. For example, when the living room cleaning history 821 is selected, a user interface window such as FIG. 9 can be displayed.

FIG. 9 is an example of the user interface window that can be displayed when one of the plurality of spaces is selected.

Referring to FIG. 9, the user interface window 900 displays a cleaning area of a specific robot cleaner for a space selected by the user. As described above, in this embodiment, not only the cleaning area is displayed by partitioning an area by a plurality of spaces, but also the detailed cleaning area image of the cleaning area selected by the user is displayed, so that the user can easily and intuitively confirm the cleaning result of the robot cleaner.

In the illustrated cleaning area image 910, a hatched area is a cleaning area and black lines indicate a movement path of the robot cleaner.

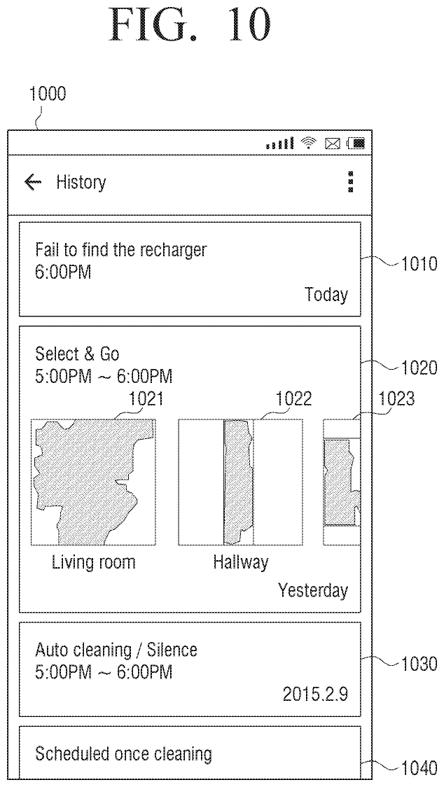

In the illustrated example, it has been described that the cleaning area and the movement path are displayed together, but in implementation, only a cleaning area can be displayed without displaying the movement path as FIG. 10.

FIG. 10 is another example of the user interface window which can be displayed when the cleaning history display area is selected.

Referring to FIG. 10, a user interface window 1000 displays a plurality of cleaning histories 1010, 1020, 1030, and 1040. One of the plurality of cleaning histories displays the cleaning area for each space by images 1021, 1022, and 1023. Compared to FIG. 8, the movement path of the robot cleaner in the images 1021, 1022, and 1023 of the cleaning area by spaces is not shown in FIG. 10. At implementation, the user can select whether to display as shown in FIG. 8 or as shown in FIG. 10 in the setting menu.

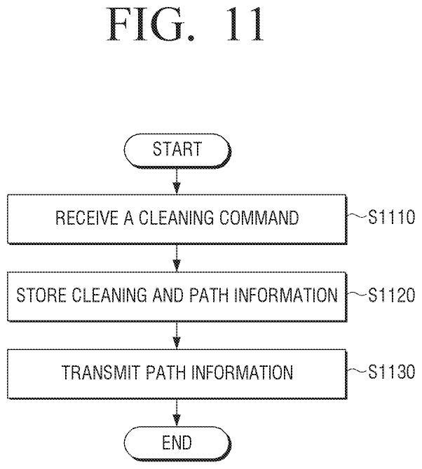

FIG. 11 is a flowchart to describe a control method of the robot cleaner according to an embodiment of the disclosure.

Referring to FIG. 11, a cleaning command is received from a user in step S 1110. Specifically, a cleaning command is received from the external terminal device 200 or a direct cleaning command is received through the manipulation inputter 130 provided in the robot cleaner 100. The received cleaning command may be a cleaning schedule.

Cleaning is performed according to the received cleaning command in step S1120. Specifically, the robot cleaner is controlled so as to move along a predetermined path, and dust can be sucked on the floor while moving to clean dust on the floor. In the meantime, if the cleaning command received from the user is a cleaning command for the specific space, the movement to the specific space may be performed in advance prior to cleaning

During the cleaning process, the cleaning path of the robot cleaner is stored.

The cleaning result information which includes the cleaning path of the robot cleaner by a plurality of spaces can be generated based on the pre-received spatial information, and the generated cleaning result information can be transmitted to the terminal device 200 in step S1130.

As described above, in the control method of the robot cleaner 100 according to the embodiment, cleaning can be performed using the spatial information partitioned into a plurality of spaces, and a cleaning operation can be performed for a specific space. In addition, the control method of the robot cleaner 100 according to the embodiment provides the cleaning path for each space to the terminal device 200 as cleaning result information, so that the user can easily check the cleaning state for each space. The control method as shown in FIG. 11 can be executed on a robot cleaner having the configuration of FIG. 2, or on a robot cleaner having other configurations.

Further, the control method as described above can be implemented as a program including algorithms executable on a computer, and the program can be stored in a non-transitory computer readable medium.

The non-transitory computer readable medium refers to a medium that stores data semi-permanently rather than storing data for a very short time, such as a register, a cache, a memory or etc., and is readable by an apparatus. In detail, the aforementioned various applications or programs may be stored in the non-transitory computer readable medium, for example, a compact disc (CD), a digital versatile disc (DVD), a hard disc, a Blu-ray disc, a universal serial bus (USB), a memory card, a read only memory (ROM), and the like, and may be provided.

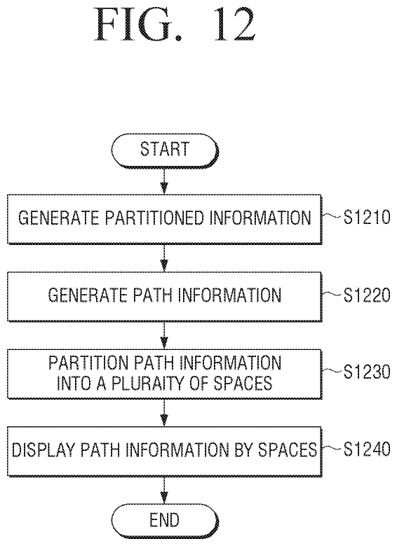

FIG. 12 is a flowchart to describe a control method of a terminal device according to an embodiment of the disclosure.

Referring to FIG. 12, spatial information partitioned into a plurality of spaces is generated and stored in step S1210. Specifically, the robot cleaner 100 receives the map information, partitions the received map information into a plurality of spaces through an algorithm to generate the partitioned information, or partitions the received map information into a plurality of spaces from the user to generate spatial information partitioned into a plurality of spaces.

The cleaning result information which includes a cleaning path is received from the robot cleaner in step S1220.

If the cleaning path received from the robot cleaner is one path, the cleaning path included in the cleaning result information may be partitioned into a plurality of spaces based on the spatial information in step S1230. If the cleaning result information received from the robot cleaner includes a cleaning path partitioned into spaces, this operation may be omitted.

Then, a cleaning area of the robot cleaner for each of a plurality of spaces is displayed in step S1240. Specifically, a cleaning area image of a plurality of space-specific robot cleaners can be generated based on a space-specific cleaning path, and a thumbnail of the generated cleaning area image by space can be displayed. If the user selects any one of the displayed thumbnails, a cleaning area image corresponding to the selected thumbnail can be displayed.

As described above, the control method of the terminal device according to the embodiment provides a space-based cleaning area to the user, so that the user can easily check the cleaning state of each space. The control method of the terminal device as shown in FIG. 12 can be executed on the terminal device having the configuration of FIG. 3 or on the terminal device having other configurations.

Further, the control method as described above can be implemented as a program including executable algorithms executable on a computer, and the program can be stored in a non-transitory computer readable medium and provided.

Non-volatile computer readable medium means a medium that stores data for a short period of time such as a register, a cache, a memory, etc., but semi-permanently stores data and can be read by a device. Specific examples of non-transitory computer readable media include compact disc (CD), digital versatile disc (DVD), hard disk, Blu-ray disk, universal serial bus (USB), memory card, read only memory (ROM), etc.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A terminal device connectable to a robot cleaner, comprising:
a storage configured to store spatial information partitioned into a plurality of spaces;
a communication interface configured to receive, from the robot cleaner, cleaning result information including a cleaning path;
a display configured to display the cleaning result information; and
a processor configured to control the display such that a cleaning area of the robot cleaner for each of the plurality of spaces is displayed on a basis of the received cleaning result information and the stored spatial information.

2. The terminal device of claim 1, wherein the processor controls the display to display a cleaning area of the robot cleaner with respect to a space in which cleaning is performed, from among the plurality of spaces.

3. The terminal device of claim 1, wherein the processor controls the display to display a map of a space in which cleaning is performed along with a cleaning area on the map.

4. The terminal device of claim 1, wherein the processor controls the display to display a cleaning area in which cleaning is performed along with a movement path of the robot cleaner on the cleaning area.

5. The terminal device of claim 1, wherein the processor is further configured to:
partition a cleaning path included in the cleaning result information into a plurality of spaces based on the spatial information, and
generate a cleaning area image of the robot cleaner by a plurality of spaces based on the partitioned cleaning path.

6. The terminal device of claim 1, wherein the cleaning result information comprises a plurality of cleaning paths which are partitioned by a plurality of spaces, and the processor generates a cleaning area image of the robot cleaner by a plurality of spaces based on the plurality of cleaning paths.

7. The terminal device of claim 1, wherein the communication interface receives, from the robot cleaner, map information generated from the robot cleaner, and the processor generates spatial information partitioned into a plurality of spaces based on the received map information and stores the same in the storage.

8. The terminal device of claim 1, wherein the processor, based on at least one space among the plurality of spaces being selected by a user, controls the communication interface so that a cleaning command with respect to the selected space is transmitted to the robot cleaner.

9. The terminal device of claim 1, wherein the processor, based on any one cleaning area being selected from among the displayed cleaning areas by spaces, controls the display to enlarge and display the selected cleaning area.

10. A robot cleaner comprising:
a driver configured to move the robot cleaner;
a suction portion configured to suck dust on a bottom of the robot cleaner;
a communication interface configured to receive spatial information partitioned into a plurality of spaces from a terminal device; and
a processor configured to:
move the robot cleaner to perform cleaning, and
control the communication interface to transmit cleaning result information including a cleaning path of the robot cleaner by a plurality of spaces based on the received spatial information to the terminal device.

11. The robot cleaner of claim 10, wherein the processor controls the communication interface to transmit, to the terminal device, cleaning result information that includes only cleaning paths of each of a space in which cleaning is performed from among the plurality of spaces.

12. The robot cleaner of claim 10, wherein the processor, based on a cleaning command for a specific space, from among the plurality of spaces, being received from the terminal device, controls the robot cleaner by moving the robot cleaner to the specific space to perform cleaning on a basis of the received spatial information.

13. The robot cleaner of claim 10,
wherein the processor controls the communication interface to generate map information according to movement of the robot cleaner and transmit the map information to the terminal device, and
wherein the spatial information, based on the generated map information being partitioned into a plurality of spaces, is location information of each of the plurality of partitioned spaces.

14. The robot cleaner of claim 10, wherein the communication interface receives cleaning schedule information from the terminal device, and the processor performs cleaning according to the received cleaning schedule information.

15. A control method of a terminal device connectable to a robot cleaner, the method comprising:
prestoring spatial information partitioned into a plurality of spaces;
receiving, from the robot cleaner, cleaning result information including a cleaning path; and
displaying a cleaning area of the robot cleaner by the plurality of spaces based on the received cleaning result information and the stored spatial information.
